(19) United States
(12) Patent Application Publication
(10) Pub. No.: US 2004/0015980 A1
(43) Pub. Date: Jan. 22, 2004

(54) Systems and methods for monitoring and controlling multiple computers

(76) Inventors: Sarah Rowen, Woodbury, MN (US); Joel Young, Eden Prairie, MN (US); Michael L. Zarns, Plymouth, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/198,644

(22) Filed: Jul. 17, 2002

(51) Int. Cl. G06F 9/00

(52) U.S. Cl. 719/310

(57) ABSTRACT

Systems and methods for substantially simultaneously controlling and monitoring multiple computers are provided. This is accomplished by routing keyboard and cursor control device signals coming from a workstation to a selected computer for controlling and by further multiplexing video signals outputted by two or more selected computers for PIP display using a KVM PIP switch.

### FIELD OF THE INVENTION

The present invention relates to systems for interconnecting computers, and more particularly to keyboard, monitor (video), and mouse (KVM) switches for monitoring multiple computers.

### BACKGROUND INFORMATION

In a typical local computer network there are a number of client computers that are coupled via a communication link to a number of network resources. These resources include file servers, print servers, and CD-ROM servers, for example. Each server is usually a stand-alone computer with its own keyboard, mouse, and video monitor. Each client computer can utilize the functions provided by the server computers through the communication link.

Most computer networks have one or more system administrators, i.e., human operators, for the server computers. System administrators monitor the operation of software running on server computers, load new software packages, delete outdated files, implement access controls, and perform other tasks to maintain the operation of the network.

All of these tasks can be performed over the network using well-known switches, such as KVM switches to provide communication capability between a single workstation and multiple computers. Workstation here refers to a computer device including a keyboard, a cursor control device, and a monitor. Such KVM switches are commercially available and offer the advantage of controlling and monitoring a large number of servers by a single workstation. In this way, large computer operations, such as server farms, network administrator areas, and other tasks can be performed in a space-efficient manner to accommodate more computers and less workstations.

While current KVM switches allow the administrator to control and monitor a large number of servers with a single workstation, drawbacks can include not being able to view more than one server at a time without requiring additional software, not being able to view the boot-up process of connected servers, and the client computers being dependent on a specific operating system. Currently, viewing multiple computers can be done, but the administrator has to install additional software on the client system, which requires significant memory and processing power. These drawbacks can significantly reduce administrator productivity for controlling and monitoring the operations of coupled computers.

For the reasons stated above, and for reasons stated below which will become apparent to those skilled in the art upon reading and understanding the present specification, there is a need in the art for a KVM switch that provides the ability to control and monitor multiple servers using one monitor/keyboard/mouse, provides the ability to monitor more than one server at a time, provides the capability to watch servers as they boot-up. In addition, there is a need in the art for a KVM switch with additional functionality to operate without additional software. Further, there is also a need for seeing multiple outputs from a KVM switch that is not dependent on a client computer with a specific operating system to improve the administrator's productivity.

### SUMMARY OF THE INVENTION

The above-mentioned shortcomings, disadvantages and problems are addressed by the present invention, which will be understood by reading and studying the following specification.

In one aspect of the present invention, a system and method is described for substantially simultaneously controlling and monitoring multiple computers. This is accomplished by routing keyboard and cursor control device signals coming from a workstation to a selected computer for controlling and by further multiplexing video signals outputted by two or more selected computers for picture-in-picture (PIP) display using a KVM PIP switch.

According to one aspect of the present invention, a method of substantially simultaneously monitoring and controlling multiple computers includes selecting a computer from the multiple computers for controlling and monitoring. Further, the method includes selecting one or more other computers from the multiple computers for substantially simultaneously monitoring the selected one or more other computers. Control signals are then transmitted to the selected computer to monitor and control the selected computer. Video signals from the selected computers are then received and multiplexed. A multiplexed video signal is then displayed using a video monitor to PIP display the video signals coming from the selected computers to facilitate substantially simultaneous controlling and monitoring.

In another aspect of the present invention, a KVM PIP switch is provided to route keyboard and cursor control device signals coming from a workstation to control a computer selected from multiple computers. Further, the KVM switch multiplexes video signals received from two or more computers selected from the multiple computers for PIP display to facilitate substantially simultaneous monitoring of the selected two or more computers.

In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram illustrating one embodiment of a multiple display KVM PIP switch system according to the present invention.

FIG. 2 is a flowchart of one embodiment of a method of displaying multiple video signals using a KVM PIP switch system according to the present invention.

### DETAILED DESCRIPTION OF THE INVENTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

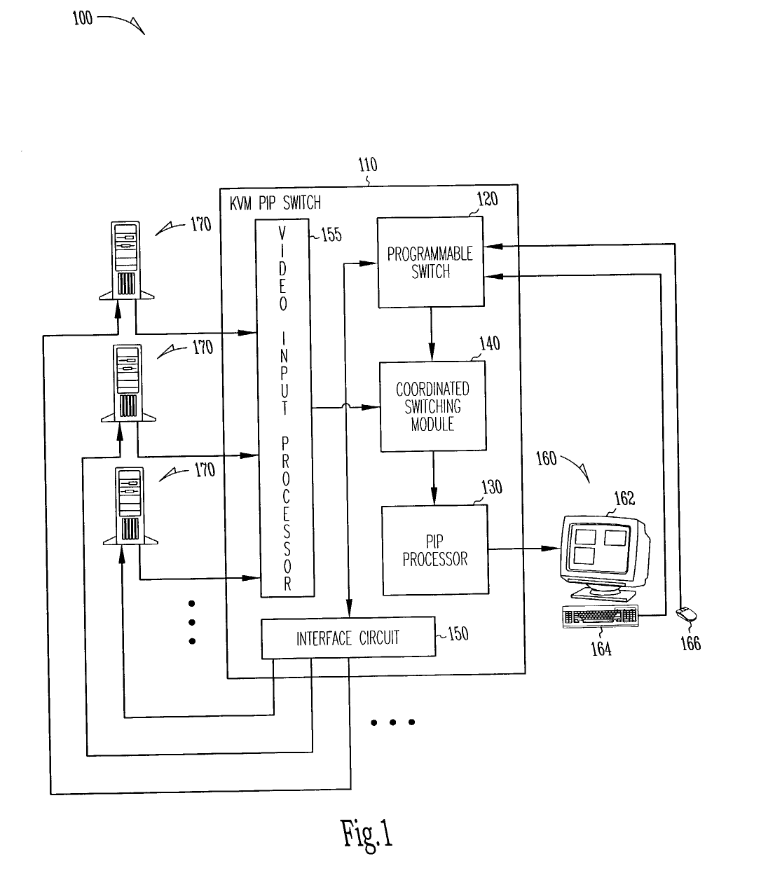

FIG. 1 is a block diagram illustrating one embodiment of a multiple display KVM switch system 100 including a KVM PIP switch 110, a workstation 160, and multiple computers 170. As shown in FIG. 1, the KVM PIP switch further includes a programmable switch 120, a PIP processor 130, a coordinated switching module 140, an interface circuit 150, and a video input processor 155. Also as shown in FIG. 1, the workstation 160 further includes a monitor 162, a keyboard 164, and a cursor control device 166.

In operation, programmable switch 120 receives keyboard 164 and cursor control device 166 signals from workstation 160 and outputs the received keyboard 164 and cursor control device 166 signals for controlling a computer selected from multiple computers 170. In addition, programmable switch 120 outputs keyboard 164 and cursor control device 166 signals based on the selected two or more computers for PIP display.

Interface circuit 150 receives the outputted keyboard and cursor control device signals from programmable switch 120 and routes them to the selected computer through programmable switch 120 to facilitate control of the selected computer. PIP processor 130 receives video signals from each of the multiple computers. In addition, PIP processor 130 receives outputted keyboard 164 and cursor control device 166 signals from the programmable switch. PIP processor 130 then outputs a video signal based on the received keyboard 164 and cursor control device 166 signals to PIP display two or more selected computers from multiple computers 170. In some embodiments, PIP processor 130 receives outputted keyboard 164 and cursor control device signals from the programmable switch and outputs a video signal based on the received keyboard 164 and cursor control device 166 signals to PIP display two or more selected computers. In some embodiments, the PIP processor outputs separate video signals for the two or more selected computers for PIP display. In these embodiments, the outputted video signals are multiplexed within a PIP monitor for PIP display of the video signals of the two or more selected computers. In some embodiments, programmable switch 120 can be a manual switch, a manual dial, buttons, a switching circuit, a KVM switch, a menu driven user interface, and/or a combination of a cursor control device.

In some embodiments, the PIP display of the two or more video signals comprises a main display and one or more PIP displays. In these embodiments, the main display includes displaying a video signal associated with the computer selected to control. One or more PIP displays include displaying one or more video signals associated with the two or more computers selected for viewing and monitoring. In some embodiments, programmable switch 120 outputs a programmable switch signal to PIP processor 130 for PIP display of the two or more video signals based on the two or more computers selected for PIP display.

In some embodiments, coordinated switching module 140 receives keyboard 164 and cursor control device 166 signals from programmable switch 120. Coordinated switching module 140 then analyzes the received keyboard 164 and cursor control device 166 signals and outputs a video selection signal. In these embodiments, PIP processor 130 receives the outputted video selection signal from the coordinated switching module 140 and outputs a multiplexed video signal to PIP display the two or more selected computers based on the outputted video selection signal. In some embodiments, video input processor 155 receives a VGA signal from each of the multiple computers and outputs a video signal that is compatible with the video signal input of PIP processor 130.

In some embodiments, video signals are displayed such that the selected computers can be viewed and monitored during boot-up as well as running of the computers. In these embodiments, the workstation 160 as well as the multiple computers 170 does not require any additional software to route the keyboard 164, the cursor control device 166, and video signals for viewing and monitoring.

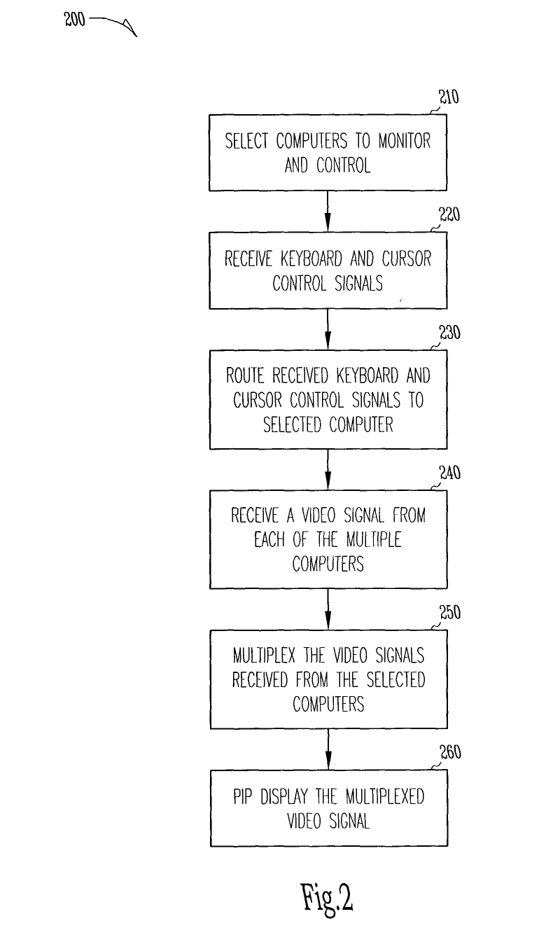

FIG. 2 is a flowchart of one exemplary method of substantially simultaneously monitoring and controlling multiple computers, according to the present invention. Flowchart 200 includes operations 210-260, which are arranged serially in the exemplary embodiment. However, other embodiments of the subject matter may execute two or more operations in parallel, using multiple processors or a single processor organized as two or more virtual machines or sub-processors. Moreover, still other embodiments implement the operations as two or more specific interconnected hardware modules with related control and data signals communicated between and through the modules, or as portions of an application-specific integrated circuit. Thus, the exemplary process flow is applicable to software, firmware, and hardware implementations.

As shown in FIG. 2, operation 210 selects computers from multiple computers to monitor and control. In some embodiments, this includes selecting a computer from multiple computers for controlling and monitoring and further selecting one or more other computers from multiple computers to view and monitor substantially simultaneously. In these embodiments, selection of two or more computers from the multiple computers is made using a manual switch, a switching circuit, character/function keys on the keyboard in combination with the monitor, and other such devices that facilitates in selecting the two or more computers from the multiple computers. In some embodiments, multiple computers include one or more computers.

Operation 220 includes receiving keyboard and cursor control device signals from the workstation to control the selected computer. Operation 230 includes routing the received keyboard and cursor control device signals to control the selected computer. Operation 240 includes receiving a video signal from each of the multiple computers. Operation 250 includes multiplexing the video signals received from the selected computers. Operation 260 includes displaying the multiplexed signal on a video monitor for PIP display such that the selected computers can be monitored substantially simultaneously.

In some embodiments, multiplexing the received video signals includes further receiving a coordinated switching signal from a programmable switch based on the selected computers for controlling and monitoring. The received video signals are then multiplexed based on the received coordinated switching signal. In some embodiments, the multiplexed signal is displayed such that the computer selected for controlling is displayed as the main display and the other one or more computers selected for monitoring are displayed as PIP display for substantially simultaneous viewing and monitoring on the video monitor. In some embodiments, video signals are displayed such that the selected computers can be viewed and monitored during boot-up as well as during operation. In these embodiments, the workstation, as well as multiple computers, do not require any additional software to route the keyboard, the cursor control device, and video signals for viewing and monitoring.

### CONCLUSION

Systems, methods, and apparatus for substantially simultaneously controlling and monitoring multiple computers have been described. Although specific embodiments have been illustrated and described herein, it will be appreciated by those of skill in the art that any arrangement, which is calculated to achieve the same purpose may be substituted for the specific embodiments shown. This application is intended to cover any adaptations or variations of the present invention. For example, although described in procedural terms, one of ordinary skill in the art will appreciate that the invention can be implemented in an object-oriented design environment or any other design environment that provides the required relationships.

In particular, one of skill in the art will readily appreciate that the names of the methods and apparatus are not intended to limit embodiments of the invention. Furthermore, additional methods and apparatus can be added to the components to correspond to future enhancements. KVM switches used in embodiments of the invention can be introduced without departing from the scope of embodiments of the invention. One of skill in the art will readily recognize that embodiments of the invention are applicable to future KVM PIP switch systems for monitoring and controlling multiple computers.

What is claimed is:

1. A device to route keyboard and cursor control device signals coming from a workstation to control a computer selected from the multiple computers and to further receive a video signal from each of the multiple computers and to output a video signal that can provide a PIP display of two or more video signals received from two or more computers selected from the multiple computers for PIP display.

2. The device of claim 1, wherein the PIP display of the two or more video signals comprises a main display and one or more PIP displays of the two or more video signals received from the two or more computers selected from the multiple computers for the PIP display.

3. The device of claim 1, comprising:
a programmable switch to receive the keyboard and cursor control device signals from the workstation and to output the received keyboard and cursor control device signals for controlling the computer selected from the multiple computers, and to further output keyboard and cursor control device signals based on the selected two or more computers for PIP display;
an interface circuit communicatively coupled between the programmable switch and the multiple computers to route the keyboard and cursor control device signals coming from the workstation to the selected computer through the programmable switch; and
a PIP processor to receive the video signal from each of the multiple computers and the outputted keyboard and cursor control device signals from the programmable switch and to output the video signal based on the outputted keyboard and cursor control device signals for PIP display of the two or more computers selected from the multiple computers.

4. The device of claim 3, wherein the programmable switch outputting keyboard and cursor control device signals, based on the selected two or more computers for PIP display, comprises outputting a programmable switch signal to the PIP processor for PIP display of the two or more video signals based on the two or more computers selected for PIP display.

5. The device of claim 3, further comprising:
a coordinated switching module coupled between the programmable switch and the PIP processor to receive the keyboard and cursor control device signals through the programmable switch and to analyze the received keyboard and cursor control device signals and to further output a video selection signal that facilitates the PIP processor to PIP display the video signals coming from the two or more computers selected from the multiple computers.

6. The device of claim 4, further comprising:
a video input processor to receive a video signal from each of the multiple computers and to output a video signal that is compatible with a video signal input of the PIP processor, wherein the received video signal is a video signal selected from the group consisting of VGA signal, digital video (DV) signal, composite video signal, component video, and streaming video.

7. The device of claim 4, wherein the programmable switch to route keyboard and cursor control device signals is a switch selected from the group consisting of a manual switch, a dial, buttons, a switching circuit, character/function keys on the keyboard in combination with the PIP display, and a combination of a cursor control device.

8. The device of claim 1, wherein the outputted video signal is a multiplexed video signal, wherein the multiplexed signal includes multiple video signals from the two or more selected computers.

9. The device of claim 1, wherein the multiple computers are multiple servers.

10. A KVM PIP switch system, comprising:
a workstation including a keyboard, a cursor control device, and a video monitor;
multiple computers; and
a KVM PIP switch communicatively coupled between the workstation and the multiple computers such that the KVM PIP switch can route the keyboard and cursor control device signals coming from the workstation to the keyboard and cursor control device inputs of a computer selected from the multiple computers, and further the KVM PIP switch can receive video signals coming from the multiple computers and output a PIP multiplexed video signal using video signals coming from any two or more selected computers to the video monitor of the workstation for PIP display to control and monitor substantially simultaneously the two or more selected computers.

11. The system of claim 10, wherein the controlling and monitoring substantially simultaneously of the two or more selected computers comprises controlling and monitoring substantially simultaneously during boot-up and operation of the two or more selected computers.

12. The system of claim 10, wherein the multiple computers are multiple servers.

13. The system of claim 10, wherein the KVM PIP switch further comprises:
a programmable switch to route the keyboard and cursor control device signals from the workstation to the computer selected from the multiple computers, and to further output keyboard and cursor control device signals based on the selected two or more computers for PIP display;
an interface circuit communicatively coupled between the programmable switch and the multiple computers to route the keyboard and cursor control device signals coming from the workstation to the selected computer through the programmable switch; and
a PIP processor to receive the video signal from each of the multiple computers and the outputted keyboard and cursor control device signals from the programmable switch and to output the video signal based on the selected two or more computers for PIP display.

14. The KVM PIP switch of claim 13, further comprising:
a coordinated switching module coupled between the programmable switch and the PIP processor to receive the programmable switch signal and to analyze the received programmable switch signal and to further output a video selection signal that facilitates the PIP processor to PIP display of the two or more video signals coming from the two or more computers selected from the multiple computers.

15. The KVM PIP switch of claim 13, further comprising:
a video input processor to receive a video signal from each of the multiple computers and to output a video signal that is compatible with a video signal input of the PIP processor, wherein the received video signal is a video signal selected from the group consisting of VGA signal, digital video (DV) signal, composite video signal, component video, and streaming video.

16. The KVM PIP switch of claim 12, wherein the programmable switch to route keyboard and cursor control device signals is a switch selected from the group consisting of a manual switch and a switching circuit.

17. A multiple display KVM switch system, comprising:
a workstation including a keyboard, a cursor control device, and a PIP video monitor;
multiple computers; and
a KVM PIP switch communicatively coupled between the workstation and the multiple computers such that the KVM PIP switch can route the keyboard and cursor control device signals coming from the workstation to the keyboard and cursor control device inputs of a computer selected from the multiple computers, further the KVM PIP switch can receive video signals coming from the multiple computers and output video signals coming from any two or more selected computers to the PIP video monitor of the workstation such that the PIP video monitor PIP displays the two or more video signals coming from the two or more selected computers, and further the two or more selected computers can be controlled and monitored substantially simultaneously using the keyboard and the cursor control device of the workstation.

18. The system of claim 17, wherein the multiple computers are multiple servers.

19. The system of claim 17, wherein the KVM PIP switch further comprises:
a programmable switch to route the keyboard and cursor control device signals from the workstation to the computer selected from the multiple computers, and to further output keyboard and cursor control device signals based on the selected two or more computers for PIP display; and
an interface circuit communicatively coupled between the programmable switch and the multiple computers to route the keyboard and cursor control device signals coming from the workstation to the selected computer through the programmable switch.

20. The system of claim 17, wherein the PIP video monitor PIP displays the two or more video signals coming from the two or more selected computers such that the selected two or more computers can be monitored during boot-up and operation of the computers.

21. In a system including a workstation of the type that includes a keyboard, cursor control device, and a video monitor connected to multiple computers, a method of transmitting keyboard, cursor control device signals and video signals between a workstation and two or more selected computers from the multiple computers connected through a programmable switch, comprising:
selecting a computer from the multiple computers for controlling and monitoring, and further selecting one or more other computers from the multiple computers for monitoring substantially simultaneously using the programmable switch;
receiving keyboard and cursor control device signals from the workstation;
routing the received keyboard and cursor control device signals to the selected computer through the programmable switch for controlling the selected computer;
receiving a video signal from each of the connected multiple computers;
multiplexing the video signal received from each of the connected multiple computers for PIP display based on the selected computers; and
displaying the multiplexed video signal on the video monitor of the workstation such that the multiplexed video signal PIP displays the video signals of the selected computers.

22. The method of claim 21, wherein multiplexing the video signal received from each of the connected multiple computers for PIP display further comprises:
receiving a coordinated switching signal from the programmable switch based on the selected computer for monitoring and controlling and further based on the selected one or more other computers for PEP display and monitoring; and
multiplexing the video signal received from each of the connected multiple computers for PIP display based on the received coordinated switching signal.

23. The method of claim 22, wherein displaying the multiplexed video signal on the video monitor of the workstation further comprises:
displaying the multiplexed video signal such that the video signal from the selected computer for controlling is displayed as a main display on the video monitor and the video signals from the selected one or more other computers are displayed as a PIP display for substantially simultaneous monitoring on the video monitor.

24. The method of claim 22, wherein displaying the video signals comprises displaying the video signals such that the selected computers can be monitored during boot-up and operation.

25. The method of claim 23, wherein the multiple computers are one or more servers.

26. The method of claim 23, wherein the workstation and the computers does not require any additional software to route the keyboard, the cursor control device, and the video signals between the workstation and the multiple computers through the programmable switch.

27. The method of claim 23, wherein the programmable switch includes a KVM switch.

28. A method for substantially simultaneously monitoring and controlling multiple computers, comprising:
selecting a computer for controlling and monitoring from the multiple computers;
selecting one or more other computers for substantially simultaneously monitoring from the multiple computers;
routing control signals to the selected computer while controlling the selected computer;
receiving video signals from the multiple computers;
multiplexing the received video signals based on the selected computers; and
displaying the multiplexed video signal on a video monitor for PIP display to facilitate substantially simultaneous monitoring of the selected computers.

29. The method of claim 28, wherein displaying the multiplexed video signal on the video monitor for PIP display further comprises:
displaying the multiplexed video signal such that the video signal from the selected computer is displayed as a main display on the video monitor and the video signals from the selected one or more other computers are displayed as a PIP display on the video monitor.

30. The method of claim 29, wherein displaying the video signals comprises displaying the video signals such that the selected computers can be monitored during boot-up and operation.
